(19) United States
(12) Patent Application Publication
(10) Pub. No.: US 2012/0224400 A1
(43) Pub. Date: Sep. 6, 2012

(54) ELECTRICAL EQUIPMENT

(75) Inventor: Fumihito IZAWA, Daito-shi (JP)

(73) Assignee: FUNAI ELECTRIC., LTD., Osaka (JP)

(21) Appl. No.: 13/409,429

(22) Filed: Mar. 1, 2012

(30) Foreign Application Priority Data
Mar. 2, 2011 (JP) 2011-045606

(51) Int. Cl. H02M 3/335

(52) U.S. Cl. 363/21.15; 363/21.12

(57) ABSTRACT

A television includes a power supply circuit including a transformer that converts input voltage to output voltage, an input voltage monitoring circuit that monitors the input voltage based on a voltage value of a primary side or a secondary side of the transformer, and a control unit that determines whether or not the input voltage exceeds a specified value based on monitoring results of the input voltage monitoring circuit and provides a warning or notification that the input voltage is excessive when it is determined that the input voltage exceeds the specified value.

### BACKGROUND OF THE INVENTION

1. Field of the Invention

The present invention relates to electrical equipment, and particularly to electrical equipment including a power supply circuit that converts input voltage to output voltage using a transformer.

2. Description of the Related Art

There are recommended operating conditions relating to currents and voltages for circuits, and in the past, various countermeasures have been taken for protecting against overcurrent and overvoltage that occur with power supply circuits.

For example, Japanese Patent Application Laid-Open Publication No. H2-311125 discloses technology for detecting overcurrent which occurs at the primary side of the transformer due to irregularities that arise in the transformer of a power supply circuit or on the load side thereof. In concrete terms, the constitution is such that when current flowing through the primary side of the transformer increases, excess voltage (hereafter referred to as overvoltage) occurs at the secondary side of the transformer, and the relay switch is switched by this overvoltage, so the output of the secondary side of the transformer is stopped.

Furthermore, Japanese Patent Application Laid-Open Publication No. H4-253485, for example, discloses technology including a microcomputer that latches overcurrent which occurs at the primary side of a transformer due to excess current (hereafter referred to as overcurrent) that occurs at the secondary side of the transformer, and when the overcurrent is latched, this microcomputer turns off a relay inserted through a transmission line of the primary side of the transformer and also lights a warning LED.

Moreover, Japanese Patent Application Laid-Open Publication No. 2010-263734, for example, discloses technology for which, when overvoltage is accidentally input to a power supply circuit, overcurrent is generated on the primary side of the transformer due to a surge absorber on the secondary side of the transformer breaking down in the short circuit mode, and a fuse provided on the primary side of the transformer is melted by this overcurrent.

In general, power supply circuits included in electrical equipment generally uses one of two types of countermeasures described below to prevent input of overvoltage to the power supply circuit.

The first countermeasure is to provide a fuse on the primary side of the transformer of the power supply circuit, and when overvoltage is input to the power supply circuit, to stop the operation of the power supply circuit as a result of the fuse being melted by the overcurrent generated by this overvoltage. The technology of Japanese Patent Application Laid-Open Publication No. 2010-263734 described above corresponds to this. In this case, trouble due to overvoltage is prevented, but the fuse is melted if overvoltage is input even once. Therefore, replacement of the fuse is required to operate the electrical equipment again. In addition, a circuit design is also required for a fuse to be melted by overcurrent generated due to overvoltage input at the primary side of the transformer.

The second type is not to perform a particular countermeasure, but rather to continue the operation “as is” as a non-guaranteed operation even if overvoltage happens to be input. In this case, the design is easier than the first type of countermeasure described above, but there is a possibility of malfunction or breakdown due to continuing operation when there is input of overvoltage.

### SUMMARY OF THE INVENTION

In light of the problems described above, preferred embodiments of the present invention provide electrical equipment that warns a user when an input voltage is in an overvoltage condition and that allows the user to select whether to continue operation or to stop the input voltage.

An electrical equipment according to a preferred embodiment of the present invention includes a power supply circuit including a transformer that converts input voltage to output voltage, a monitoring circuit that monitors the input voltage based on a voltage value of a primary side or a secondary side of the transformer, and a warning device arranged to determine whether or not the input voltage exceeds a specified value based on a monitoring result of the monitoring circuit and, when it is determined that the input voltage has exceeded the specified value, the warning device provides a warning indicating that the input voltage is excessive.

In another preferred embodiment of the present invention, the monitoring circuit preferably monitors fluctuations in the input voltage based on the voltage of the primary side of the transformer provided in the power supply circuit or preferably monitors fluctuations in the input voltage based on the voltage of the secondary side of the transformer provided in the power supply circuit. Note that the input voltage referred to here indicates, when the input voltage is AC, a value of the AC such as an effective value, a maximum value, or an average value rather than an instantaneous value.

The warning device preferably determines whether or not the input voltage exceeds a specified value based on the monitoring results of the monitoring circuit, and when it is determined that the input voltage has exceeded the specified value, the warning device displays on a display screen a warning or notification indicating that the input voltage is excessive.

As a result, the user sees the warning displayed by the warning device and becomes aware that the input voltage is abnormal and is able to judge whether or not to stop the input of the input voltage. For example, the user can decide whether to pull the AC plug from the AC socket thereby stopping supply of AC power, or whether to operate the electrical equipment “as is.” At this time, if the user pulls the plug from the AC socket, a breakdown or malfunction of the electrical circuit is kept to a minimum, however, it is also possible to keep operating “as is” while being aware of the risk at the user's discretion. Furthermore, because it is not necessary to incorporate a fuse, the circuit design becomes easier, and because no replacement of components due to melting of a fuse is required, repair costs also are avoided.

Moreover, according to another preferred embodiment of the present invention, the transformer is a flyback transformer, and the monitoring circuit monitors the input voltage based on a forward voltage that is output by the transformer. With a flyback-scheme power supply circuit, the power supply circuit uses voltage for which the flyback voltage has been rectified and smoothed as the drive voltage to drive the load, and normally forward voltage is not used. This forward voltage has the characteristic of fluctuating according to fluctuations of the input voltage.

With this constitution, by monitoring with a focus on forward voltage which is normally not used, it is possible to monitor fluctuations of the input voltage at the primary side of the transformer while also monitoring the secondary side of the transformer. The warning device preferably is driven by the power supply circuit and is positioned at the secondary side of the power supply circuit. Therefore, when transmitting the detection results from the monitoring circuit to the warning device, it is possible to transmit the detection results to the warning device without electrically insulation using a photocoupler or the like, so the monitoring circuit can be realized with low cost.

In addition, according to another preferred embodiment of the present invention, the monitoring circuit preferably includes a photocoupler, and when the voltage for which the input voltage has been rectified and smoothed exceeds the specified value, a light-emitting element of the photocoupler emits light so as to generate current at a light-receiving element of the photocoupler, and upon detection of the voltage generated by the current that flows to the light-receiving element of the photocoupler, the warning device performs a warning display relating to the abnormality of the input voltage on a display screen. Note that this constitution can be applied to a power supply circuit including a flyback transformer as the transformer, and can also be applied to power supply circuits including other types of transformers.

With this constitution, the monitoring circuit monitors the input voltage directly at the primary side of the transformer, so the detection precision is higher than when detecting the input voltage indirectly at the secondary side of the transformer. This is because there is inductor variation on the transformer.

Furthermore, according to a further preferred embodiment of the present invention, the transformer is a flyback transformer, the monitoring circuit includes a diode including a cathode that is connected to a negative electrode side of a secondary coil of the transformer, and an electrolytic capacitor including a negative electrode that is connected to the anode of the diode and a positive electrode that is connected to ground, and the warning device determines whether or not the input voltage has exceeded the specified value based on the forward voltage of the transformer that is rectified and smoothed by the diode and the electrolytic capacitor.

Moreover, according to yet another preferred embodiment of the present invention, the monitoring circuit includes a voltage-dividing circuit including dividing resistors connected between a transmission line of the voltage for which the input voltage is rectified and smoothed and a ground, a field-effect transistor including a gate that is connected to division points of the dividing resistors, and a photocoupler including a light-emitting diodes and a phototransistor, the light-emitting diode includes an anode facing the transmission line and a cathode facing the ground, a drain-source and resistors of the field-effect transistor are serially connected between the transmission line and the ground, and when the voltage for which the input voltage has been rectified and smoothed exceeds the specified value, the field-effect transistor is turned on, current flows to the light-emitting diode, and due to the light-emitting diode emitting light, current is generated at the phototransistor, and upon detection of the voltage generated by the current that flows to the light-receiving element of the photocoupler, the warning device performs a warning display relating to an abnormality of the input voltage on a display screen.

As described above, various preferred embodiments of the present invention provide electrical equipment which can warn the user of overvoltage when the input voltage is too large, while continuing operation of the equipment, thus allowing the user to decide whether to take safety precautions or not.

In addition, with various preferred embodiments of the present invention, it is possible to realize the monitoring circuit at low cost and improve the detection precision of the monitoring circuit.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram showing in model form an external view of a television.

FIG. 2 is one example of a notification displayed on a television screen when connected to a power supply of a voltage that exceeds recommended operating conditions.

FIG. 3 is a block diagram showing the schematic constitution of a television.

FIG. 4 is a diagram illustrating flyback voltage and forward voltage of a power supply circuit.

FIG. 5 is a circuit diagram showing a first working example according to a preferred embodiment of the input voltage monitoring circuit.

FIG. 6 is a circuit diagram showing a second working example according to a preferred embodiment of the input voltage monitoring circuit.

### DETAILED DESCRIPTION OF THE PREFERRED EMBODIMENTS

Preferred embodiments of the present invention will be described below with reference to the drawings.

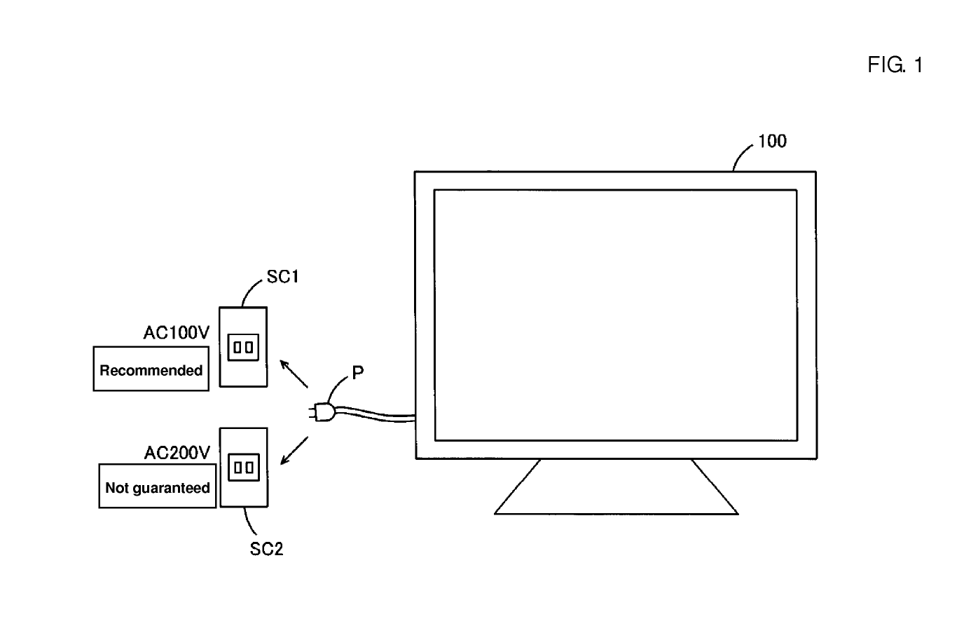

FIG. 1 is a diagram showing in model form an external view of a television. The television shown in FIG. 1 is one example of the electrical equipment according to a preferred embodiment of the present invention. Note that the electrical equipment of preferred embodiments of the present invention includes devices that may contain not only analog circuits but also electronic circuits such as integrated circuits (ICs), for example.

When the television 100 shown in FIG. 1 is connected to a power supply having a voltage exceeding recommended operating conditions, operation is possible using this power supply, but when operated using this power supply, there is a possibility of malfunction or breakdown of the television 100. For example, with the television 100, the recommended operating conditions of the power supply are AC 100 V, and the AC plug P is basically recommended to be connected to an AC 100 V AC socket SC1, but even if the AC plug P is connected to an AC 200 V AC socket SC2, though operation is not guaranteed and breakdown or malfunction is possible, operation is tentatively possible. In light of this, the television 100 is designed to notify the user of the fact that it is connected to a power supply of a voltage that exceeds the recommended operating conditions.

Notification to the user is preferably performed when the power supply circuit (described later) provided in the television 100 starts generating various types of power supply voltages based on the AC power supply voltage.

For example, if the electrical equipment is of the type that immediately shifts to a standby state or an ON state when the AC plug P is connected to the AC socket, i.e., equipment for which the power supply circuit starts supply of power supply voltage to each component immediately when the AC plug P is connected to the AC socket, then notification is performed when the user connects the AC plug P to the AC socket. Furthermore, for example, if the electrical equipment is of the type that does not shift to the standby state or the ON state until the main power is turned on, i.e., equipment for which the power supply circuit does not start supply of the power supply voltage to each component until the main power supply is turned on, then notification is performed when the user turns on the main power supply.

It is also conceivable that the user will desire this operation even while being aware of the risk of operation with a power supply that exceeds the recommended operating conditions, so a setting item to select whether or not to have this notification may also be provided. In this case, the user can select a setting so as not to have the notification performed via the setting screen or the like.

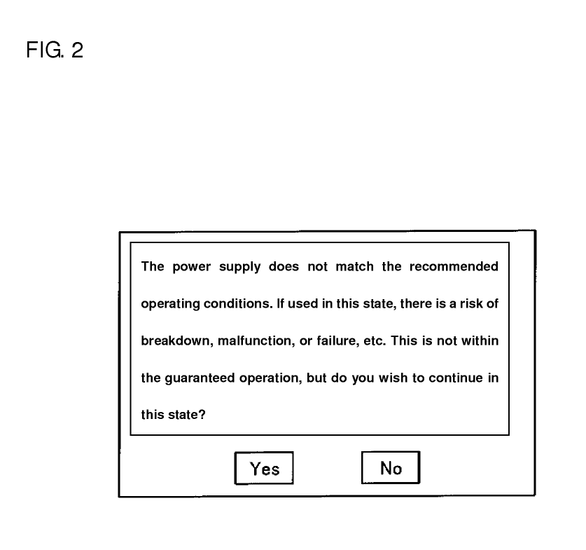

FIG. 2 is one example of the notification displayed on the screen of the television 100 when connected to a power supply for which the voltage exceeds the recommended operating conditions. In FIG. 2, the screen of the television 100 preferably displays a message of, for example, “The power supply does not match the recommended operating conditions,” to give a warning or notice that the connected power supply exceeds the recommended operating conditions (i.e., that the input voltage is excessive), and may also display a message of, for example,

“If used in this state, there is a risk of breakdown, malfunction, failure, etc.,” to provide a warning or notice of the risk if operation continues in this state. The above-described messages are non-limiting examples and can be changed as appropriate, and may also be very straightforward, such as, for example, “Connected to other than AC 100 V (rated power supply)” and, “Please unplug.”

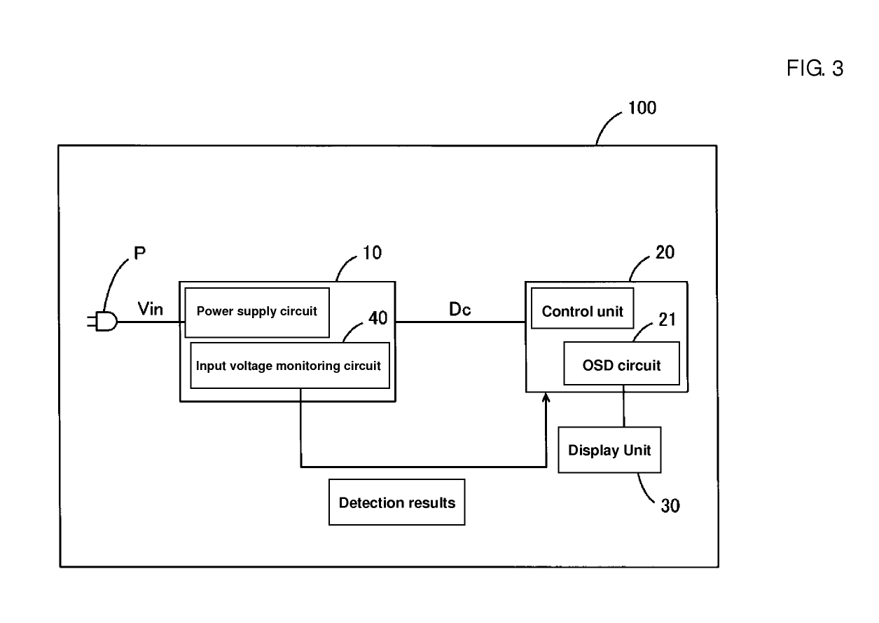

Moreover, the screen preferably also displays a message of, for example, “This is not within the guaranteed operating conditions, but do you wish to continue in this state?” to have the user select whether or not to continue using “as is.” Here, when the user operates an operation input unit such as a remote control to select “Yes” to continue use, the television 100 starts up and operates “as is” in the non-guaranteed state. Meanwhile, if the user selects “No” so as not to continue use, the television 100 stops the startup operation, and the power supply circuit halts generation of the power supply voltage. At this time, it is also possible to further display a message such as, “Please unplug,” for instance. As a configuration for executing such notification, the television 100 preferably has the configuration shown in FIG. 3.

FIG. 3 is a block diagram showing the schematic constitution of the television 100. As is shown in FIG. 3, the television 100 preferably includes a flyback scheme power supply circuit 10 that converts AC power, which is input from the AC plug P using a flyback transformer, to various types of power supply voltages and outputs the power supply voltages, a control unit 20 which operates using the power supply voltage supplied from the power supply circuit 10, and a display unit 30 which displays various types of information on the screen according to the control of the control unit 20. The power supply circuit 10 can supply power supply voltage to various elements and components other than the control unit 20 and the display unit 30, and the load is not limited to being the control unit 20 or the display unit 30.

The power supply circuit 10 preferably includes an input voltage monitoring circuit 40 that preferably monitors a voltage value of the input voltage Vin of the power supply circuit 10. The input voltage monitoring circuit 40 outputs the monitoring results of the input voltage Vin to the control unit 20. Note that the input voltage monitoring circuit 40 may also be provided outside of the power supply circuit 10.

The control unit 20 preferably includes an on-screen display (OSD) circuit 21 to display the warnings or notifications described above on the display unit 30. Specifically, the control unit 20 that includes the OSD circuit 21 and displays notifications on the display unit 30 defines a warning device according to the present preferred embodiment. Note that the control unit 20 receives the power supply voltage from the power supply circuit 10, and is positioned at the secondary side of the transformer of the power supply circuit 10. In addition, the voltage supplied from the power supply circuit 10 to the load of the control unit 20 or the like is supplied via a regulator or the like, so even if a voltage that is higher than normal due to an effect of the input voltage Vin is output from the power supply circuit 10, the load of the control unit 20 or the like is capable of tentative operation.

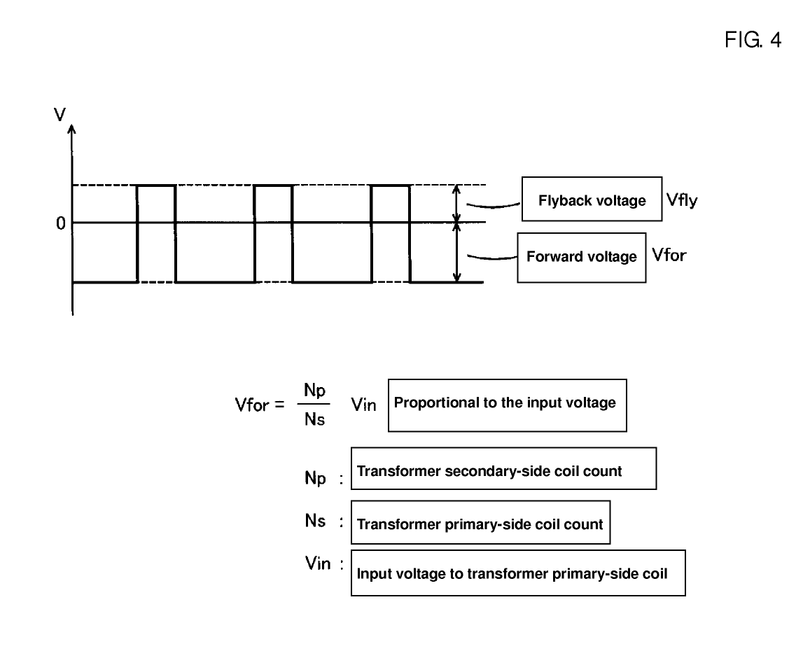

Because the power supply circuit 10 preferably uses a flyback scheme as described above, a flyback voltage is output to the load. FIG. 4 is a diagram illustrating the flyback voltage and forward voltage of the power supply circuit 10. The voltage shown in FIG. 4 indicates voltage generated at the secondary coil of the transformer of the power supply circuit 10. As is shown in FIG. 4, the flyback voltage Vfly generated at the side higher than the reference voltage (0 V) (plus side) is not easily affected by the quantity of the input voltage Vin, and whether the input voltage Vin is 100 V or 200 V, the flyback voltage Vfly remains at an almost fixed value. Meanwhile, the forward voltage Vfor generated on the side lower than the reference voltage (0 V) (minus side) has the characteristic that the greater the input voltage Vin, the greater the absolute value, and the smaller the input voltage Vin, the smaller the absolute value.

Therefore, in the present preferred embodiment, as the monitoring scheme of the input voltage monitoring circuit 40, two schemes are proposed, i.e., a scheme of directly monitoring the input voltage Vin of the primary side of the flyback transformer (hereafter, the first working example) and a scheme of indirectly monitoring the input voltage Vin based on the forward voltage Vfor generated at the secondary side of the flyback transformer (hereafter, the second working example). Note that the scheme according to the first working example has the benefit of high precision but is also high cost. On the other hand, the scheme according to the second working example has approximately a ten percent lower precision level than the former scheme due to transformer inductor variation, but it has the benefit of being low cost.

### FIRST WORKING EXAMPLE

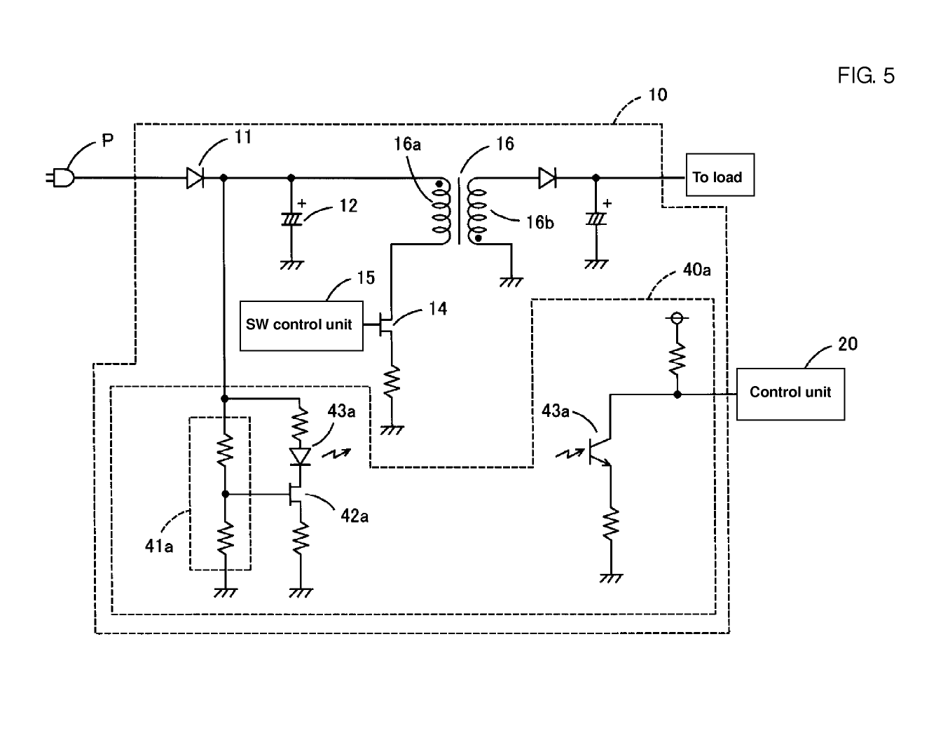

FIG. 5 is a circuit diagram showing a first working example of the input voltage monitoring circuit according to a preferred embodiment of the present invention. FIG. 5 also illustrates the circuit configuration of the power supply circuit which is subject to monitoring of the input voltage monitoring circuit.

As is shown in FIG. 5, the power supply circuit 10 is preferably designed to have AC power input via the AC plug P and preferably includes a rectifier circuit 11 that rectifies the AC power and converts it to DC, a smoothing circuit 12 that removes ripples from the DC voltage output by the rectifier circuit 11, a transformer 16 that applies the rectified and smoothed DC voltage to a primary coil 16a, a switching element 14 arranged to switch on and off the application of DC voltage to the primary coil 16a of the transformer 16, and a switching control unit 15 that controls the on/off status of the switching element 14.

The rectifier circuit 11 may preferably be constituted by a diode bridge circuit or the like, for example.

The smoothing circuit 12 may preferably be constituted by a smoothing capacitor or the like, for example.

The transformer 16 may preferably be constituted by a flyback transformer. Note that the input voltage monitoring circuit 40 according to this first working example preferably has, as the monitoring subject, the voltage of the primary side of the transformer, so it can also be applied to power supply circuits constituted by transformers other than flyback transformers.

The switching element may preferably be constituted by a MOSFET (field-effect transistor), for instance.

The switching control unit 15 may preferably be a self-excitation-type switching circuit or a separate-excitation-type switching circuit, for example.

As is shown in FIG. 5, the input voltage monitoring circuit 40a preferably includes a voltage-dividing circuit 41a that divides the DC voltage Vdc that has been obtained by rectifying and smoothing the input voltage Vin into specified proportions, a switching element 42a that turns on when the divided voltage Vdiv output by the voltage-dividing circuit 41a exceeds a specified value, and a photocoupler 43a that is arranged to operate such that, when the switching element 42a is turned on, a light-emitting element of the photocoupler 43 emits light and a light-receiving element of the photocoupler 43 receives the emitted light, and a voltage signal is input to the control unit 20. The photocoupler 43a preferably includes, for example, a light-emitting diode as the light-emitting element and a phototransistor as the light-receiving element. The voltage-dividing circuit 41a may preferably be constituted by dividing resistors, for instance. The switching element 42a may preferably be constituted by an FET (field-effect transistor), for example.

The voltage-dividing circuit 41a is provided between the DC voltage Vdc transmission line and ground, and when the input voltage Vin is a specified voltage exceeding the recommended operating conditions, adjustment is made so as to output the aforementioned specified value as the divided voltage Vdiv. For example, when voltage-dividing circuit 41a includes dividing resistors, output is from the division point of the dividing resistors. At this time, when the switching element 42a is constituted by a FET, the division point of the dividing resistors is connected to the FET gate. Specifically, the voltage-dividing circuit 41a does not turn on the switching element 42a when the divided voltage Vdiv is the aforementioned specified value or less, and does turn on the switching element 42a when the divided voltage Vdiv exceeds the aforementioned specified voltage.

Note that the specified voltage preferably is a voltage at which there is a possibility of breakdown or malfunction of any of the circuits constituting the television 100 when a voltage that exceeds this specified voltage is input, or is a voltage for which it is stipulated in certain standards that this specified voltage must not be exceeded, and in the present preferred embodiment, it is assumed that the recommended operating voltage is 100 V, while this specified voltage is 200 V (double voltage), for example.

The light-emitting element of the photocoupler 43a is serially connected with the resistor, and the circuit defined by this serial connection is connected between the DC voltage Vdc transmission line and ground. The circuit defined by this serial connection has a resistance value preferably set such that the current that flows when the input voltage Vin exceeds the aforementioned specified voltage at least can cause the light-emitting element to emit light.

The switching element 42a is preferably constituted such that the current that flows to the serial circuit defined by the light-emitting element of the photocoupler 43a and the resistor can be turned on and off based on the divided voltage Vdiv. For example, when the switching element 42a is constituted by a FET, the FET source-drain is serially inserted into the serial circuit defined by the light-emitting element of the photocoupler 43a and the resistor.

When the divided voltage Vdiv is the aforementioned specified value or less, the switching element 42a does not turn on, so the current does not flow to the serial circuit defined by the light-emitting element and the resistor, and as a result, the light-emitting element of the photocoupler 43a does not emit light, so the specified voltage signal is not input to the specified terminal of the control unit 20. On the other hand, when the divided voltage Vdiv exceeds the aforementioned specified value, the switching element 42a turns on, current flows to the serial circuit defined by the light-emitting element and the resistor, and as a result, the light-emitting element of the photocoupler 43a emits light, so the specified voltage signal is input to the specified terminal of the control unit 20.

The control unit 20 periodically detects the voltage input to the specified terminal, and when it is detected that the specified voltage signal is input to the specified terminal, the control unit 20 controls the OSD circuit 21, and displays, for example, the warning or notification shown in FIG. 2 on the display unit 30 or other desired warning or notification.

As a result, when the user connects the AC plug P of the television 100 to the AC 200 V AC socket, and the power supply circuit 10 starts generating various types of power supply voltages based on the AC 200 V, displayed on the display unit 30 of the television 100 is the message, for example, “The power supply does not match the recommended operating conditions,” or the message, for example, “If used in this state, there is a risk of breakdown, failure, or malfunction.” The user who sees this warning or notification can select to reconnect the television 100 to an AC 100 V AC socket or to continue the operation “as is” while being aware of the risk.

### SECOND WORKING EXAMPLE

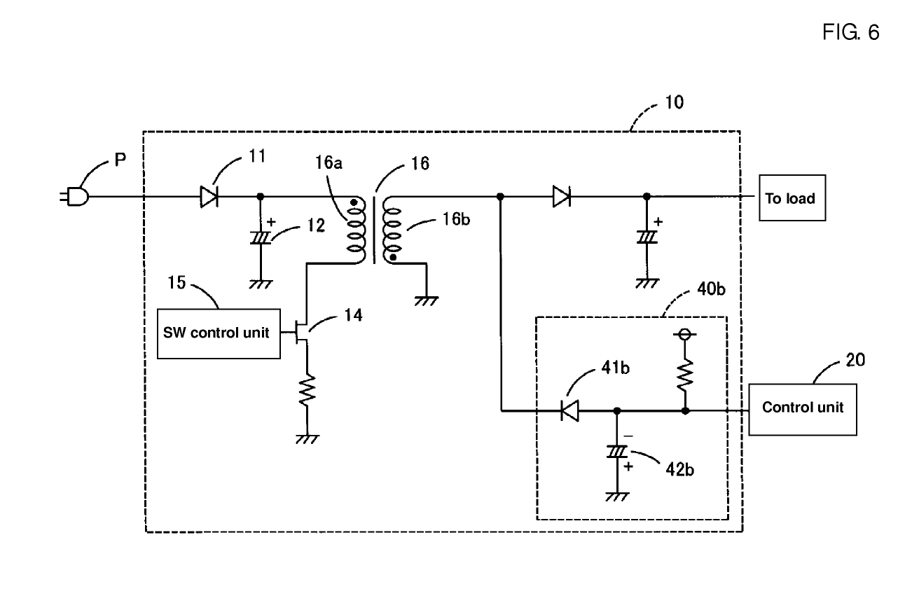

FIG. 6 is a circuit diagram showing the second working example of the input voltage monitoring circuit according to another preferred embodiment of the present invention. FIG. 6 also illustrates the power supply circuit which is subject to monitoring by the input voltage monitoring circuit, but because the constitution of the power supply circuit is preferably the same or substantially the same as that of the first working example described above, the same symbols included in FIG. 5 are assigned to the power supply circuit in FIG. 6, and an explanation is omitted hereafter.

The input voltage monitoring circuit 40b preferably includes a rectifier circuit 41b that rectifies the forward voltage Vfor output from the negative electrode of the secondary coil 16b of the transformer 16 which is a flyback transformer, and a smoothing circuit 42b that smoothes the DC output by the rectifier circuit 41b. Note that in this second working example, the power supply voltage supplied to each load (control unit 20 or the like) from the transformer 16 is one for which the flyback voltage Vfly output from the secondary coil of the transformer 16 has been rectified and smoothed.

The rectifier circuit 41b may preferably be constituted by a diode for which the cathode is connected to the negative electrode side of the secondary coil of the flyback transformer and the anode is connected to the smoothing circuit 42b, for example. The smoothing circuit 42b may preferably be constituted by an electrolytic capacitor for which the negative electrode is connected to the output line of the rectifier circuit 41b, for example. The forward voltage Vfor that is rectified and smoothed by the rectifier circuit 41b and the smoothing circuit 42b is input to the specified terminal of the control unit 20. The control unit 20 periodically monitors the voltage input to the specified terminal, and when it is detected that the forward voltage Vfor input to the specified terminal has gone below a specified value, it determines that the input voltage Vin has exceeded the specified voltage.

As a result, when the input voltage Vin is the aforementioned specified voltage or less, the forward voltage Vfor input to the specified terminal of the control unit 20 does not go below the specified value, so the control unit 20 does not perform a notification to the display unit 30, and when the input voltage Vin exceeds the aforementioned specified voltage, the forward voltage Vfor input to the specified terminal of the control unit 20 goes below the specified value, so the control unit 20 controls the OSD circuit 21 and displays on the display unit 30 the warning or notification shown in FIG. 2, for example.

Specifically, when the user connects the AC plug P of the television 100 to the AC 200 V AC socket, and the power supply circuit 10 starts generating power supply voltage based on AC 200 V, displayed on the display unit 30 of the television 100 is, for example, the message, “The power supply does not match the recommended operating conditions,” or the message, for example, “If used in this state, there is a risk of breakdown, failure, or malfunction.” The user who sees this can select to reconnect the television 100 to an AC 100 V AC socket or to continue the operation “as is” while being aware of the risk.

The television 100 including the power supply circuit 10 that converts the input voltage Vin to output voltage using the transformer 16 described above preferably includes an input voltage monitoring circuit 40a (or input voltage monitoring circuit 40b) which monitors the input voltage Vin based on the voltage value of the primary side or secondary side of the transformer, and the control unit 20 which judges whether or not the input voltage Vin exceeds the specified value based on the monitoring results of the input voltage monitoring circuit 40a (or input voltage monitoring circuit 40b), and which displays on a specified screen of the display unit 30 a warning or notification to the effect that the input voltage Vin is excessive when it is judged that the input voltage Vin exceeds the specified value. Thus, when the input voltage Vin is in an overvoltage condition, the user is warned or notified of this, and the user can use his discretion to select whether to continue the operation or to stop the input voltage.

The present invention is not limited to the working examples and preferred embodiments described above.

For example, various combinations of the mutually substitutable members, constitutions, and the like disclosed in the aforementioned working examples and preferred embodiments of the present invention are possible within the scope of the present invention.

Also, substituting members, constitutions, and the like which are not disclosed in the aforementioned working examples and preferred embodiments but are publicly known technology and which are mutually substitutable for the members, constitutions, and the like disclosed in the aforementioned working examples and preferred embodiments, and/or suitably changing the combinations thereof are possible within the scope of the present invention.

Further, substituting members, constitutions, and the like which are not disclosed in the aforementioned working examples and preferred embodiments but which can be envisioned by a person skilled in the art as substitutes for the members, constitutions, and the like disclosed in the aforementioned working examples based on publicly known technology or the like, and/or suitably changing the combinations thereof are possible within the scope of the present invention.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electrical equipment comprising:
a power supply circuit arranged to have power input;
a monitoring circuit arranged to monitor input voltage of the power input; and
a warning device arranged to determine whether or not the input voltage has exceeded a specified value based on monitoring results of the monitoring circuit; wherein
when the warning device determines that the input voltage has exceeded the specified value, the warning device provides a warning indicating that the input voltage is excessive.

2. The electrical equipment according to claim 1, wherein the power supply circuit includes a transformer arranged to convert the input voltage to output voltage, and the monitoring circuit is arranged to monitor the input voltage based on a voltage value of a primary side or a secondary side of the transformer.

3. The electrical equipment according to claim 2, wherein the transformer is a flyback transformer, and the monitoring circuit monitors the input voltage based on a forward voltage that is output by the transformer.

4. The electrical equipment according to claim 1, wherein the monitoring circuit includes a photocoupler, and when a voltage for which the input voltage has been rectified and smoothed exceeds the specified value, a light-emitting element of the photocoupler emits light thereby generating current at a light-receiving element of the photocoupler, and upon detection of a voltage generated by the current that flows to the light-receiving element of the photocoupler, the warning device performs a warning display relating to an abnormality of the input voltage on a display screen.

5. The electrical equipment according to claim 2, wherein the transformer is a flyback transformer, the monitoring circuit includes a diode including a cathode that is connected to a negative electrode side of a secondary coil of the transformer, and an electrolytic capacitor including a negative electrode that is connected to an anode of the diode and a positive electrode that is connected to ground, and the warning device determines whether or not the input voltage has exceeded the specified value based on the forward voltage of the transformer that is rectified and smoothed by the diode and the electrolytic capacitor.

6. The electrical equipment according to claim 1, wherein the monitoring circuit comprises:
a voltage-dividing circuit including dividing resistors connected between a transmission line of a voltage for which the input voltage is rectified and smoothed and a ground;
a field-effect transistor including a gate that is connected to division points of the dividing resistors; and
a photocoupler including a light-emitting diode and a phototransistor; wherein
the light-emitting diode includes an anode facing the transmission line and a cathode facing the ground, a drain-source and resistors of the field-effect transistor are serially connected between the transmission line and the ground; and
when the voltage for which the input voltage has been rectified and smoothed exceeds the specified value, the field-effect transistor is turned on, current flows to the light-emitting diode, and due to the light-emitting diode emitting light, current is generated at the phototransistor; and
upon detection of the voltage generated by the current that flows to the light-receiving element of the photocoupler, the warning device performs a warning display relating to an abnormality of the input voltage on a display screen.
a field-effect transistor including a gate that is connected to division points of the dividing resistors; and
a photocoupler including a light-emitting diode and a phototransistor; wherein
the light-emitting diode includes an anode facing the transmission line and a cathode facing the ground, a drain-source and resistors of the field-effect transistor are serially connected between the transmission line and the ground; and
when the voltage for which the input voltage has been rectified and smoothed exceeds the specified value, the field-effect transistor is turned on, current flows to the light-emitting diode, and due to the light-emitting diode emitting light, current is generated at the phototransistor; and
upon detection of the voltage generated by the current that flows to the light-receiving element of the photocoupler, the warning device performs a warning display relating to an abnormality of the input voltage on a display screen.
